(19) United States
(12) Patent Application Publication
(10) Pub. No.: US 2026/0066261 A1
(43) Pub. Date: Mar. 5, 2026

(54) METHOD AND SYSTEM OF MANUFACTURING DRY ELECTRODE

(71) Applicants: Hyundai Motor Company, Seoul (KR); Kia Corporation, Seoul (KR)

(72) Inventor: Hyun Jin KIM, Hwaseong-si (KR)

(21) Appl. No.: 19/219,730

(22) Filed: May 27, 2025

(30) Foreign Application Priority Data
Sep. 5, 2024 (KR) 10-2024-0120715

(51) Int. Cl. H01M 4/04

(52) U.S. Cl. CPC H01M 4/0435

(57) ABSTRACT

A method for manufacturing a dry electrode includes supplying a dry electrode mixture to a pelletizing device that includes a pellet pattern, pelletizing the dry electrode mixture using the pelletizing device to generate a pelletized dry electrode mixture, and supplying the pelletized dry electrode mixture to a film forming device.

### CROSS REFERENCE TO RELATED APPLICATION

The present application claims priority to Korean Patent Application No. 10-2024-0120715, filed Sep. 5, 2024, the entire contents of which are incorporated herein for all purposes by this reference.

### TECHNICAL FIELD

The present disclosure relates to manufacturing a dry electrode.

### BACKGROUND

Rechargeable secondary batteries may be applied in various fields from small electronic devices to large energy storage systems. For instance, secondary batteries may be used for electric vehicles.

Electrodes of the secondary batteries may be manufactured through a wet process. In the wet process, the electrode active material, binder, and conductive material included in the electrode are dissolved in a solvent to manufacture a slurry. In some cases, dry processes may be used to increase the energy density of batteries, compared to wet processes, where the dry process may not use the solvents of the wet processes.

For instance, in the dry process of manufacturing an electrode, the electrode active material, conductive material, and binder are mixed without a solvent to provide a mixture, and then a dry electrode film is produced by pressing or calendering. The manufacturing process of the electrode may be completed by bonding the provided dry electrode film to a current collector.

Compared to the wet electrode manufacturing process, the dry electrode manufacturing process may reduce manufacturing time and cost by eliminating the use of a solvent and may control the film thickness to obtain a dry electrode film with high energy density.

The dry electrode technology may have technical challenges to overcome. For example, due to the nature of the materials, dry electrode mixtures tend to have a large angle of repose and clump together. These characteristics of dry electrode mixtures may cause difficulties in their manufacturing, transport, or storage.

### SUMMARY

The present disclosure describes a pelletizing device for manufacturing a dry electrode mixture, which may facilitate the transport or storage of the dry electrode mixture.

According to one aspect of the subject matter described in this application, a method for manufacturing a dry electrode includes supplying a dry electrode mixture to a pelletizing device including a pellet pattern, pelletizing the dry electrode mixture using the pelletizing device to generate a pelletized dry electrode mixture, and supplying the pelletized dry electrode mixture to a film forming device.

Implementations according to this aspect can include one or more of the following features. For example, pelletizing the dry electrode mixture may include applying pressure to the dry electrode mixture while the dry electrode mixture passes through the pelletizing device. In some examples, pelletizing the dry electrode may further include heating the dry electrode mixture while the dry electrode mixture passes through the pelletizing device.

In some implementations, pelletizing the dry electrode may include spraying fluid toward the pellet pattern through a fluid line provided in the pelletizing device to thereby separate a dry electrode mixture pellet from the pelletizing device. In some examples, the pellet pattern may include one or more recesses that are recessed from a surface of the pelletizing device.

In some implementations, supplying the dry electrode mixture to the pelletizing device may include supplying a solid electrolyte film to the pelletizing device such that the dry electrode mixture is surrounded by the solid electrolyte film. In some examples, pelletizing the dry electrode mixture may include obtaining a pellet from the pelletizing device in a state in which the dry electrode mixture is surrounded by the solid electrolyte film. In some examples, the solid electrolyte film may include a polymer, a lithium salt, and an initiator.

In some implementations, the method may include, before supplying the dry electrode mixture to the pelletizing device, obtaining the dry electrode mixture by mixing an electrode active material, a binder, and a conductive material. In some examples, the method may include forming a dry electrode film from the pelletized dry electrode mixture supplied to the film forming device.

In some implementations, the dry electrode may be manufactured using the pelletized dry electrode mixture. In some examples, a battery may include the dry electrode.

According to another aspect, a pelletizing device includes a plurality of roller dies that include a pellet pattern, where the plurality of roller dies are configured to apply at least one of heat or pressure to a material that passes through the plurality of roller dies.

Implementations according to this aspect can include one or more of the following features. For example, the pellet pattern may include one or more recesses that are recessed from a surface of each of the plurality of roller dies. In some examples, each of the plurality of roller dies may include a core and a sleeve, where the sleeve surrounds the core and is configured to rotate around the core.

In some implementations, the core may be fixed to the pelletizing device and may include a heating line configured to transfer heat. In some examples, the sleeve may include a fluid line that is in fluidly communication with the pellet pattern.

In some implementations, the pelletizing device may include a hopper configured to supply the material to the plurality of roller dies and an unwinder configured to supply a film to the plurality of roller dies. In some examples, the unwinder is one of at least two unwinders, where each of the at least two unwinders is configured to supply the film to one of the plurality of roller dies with the material placed between the plurality of roller dies.

In some examples, the material may include an electrode active material, a binder, and a conductive material.

In some implementations, a dry electrode mixture pelletizing device may be provided to facilitate the transport and storage of the dry electrode mixture.

### BRIEF DESCRIPTION OF THE DRAWINGS

The above and other objectives, features, and other advantages of the present disclosure will be more clearly understood from the following detailed description when taken in conjunction with the accompanying drawings.

FIG. 1 is a view schematically showing an example of a process for manufacturing a dry electrode.

FIG. 2 is a front view showing an example of a pelletizing device for a dry electrode mixture.

FIG. 3 is a side view of FIG. 2.

FIG. 4 is a perspective view showing an example of roller dies in a pelletizing device for a dry electrode mixture.

FIGS. 5A and 5B show a front view and a side sectional view, respectively, of an example of a roller die in a pelletizing device for a dry electrode mixture.

FIGS. 6A and 6B show a front view and a side sectional view, respectively, of an example of a roller die in a pelletizing device for a dry electrode mixture.

FIG. 7 is a front view showing example of roller dies in a pelletizing device for a dry electrode mixture.

FIG. 8 is an exploded perspective view showing the roller die.

FIG. 9 is a front view showing an example of a roller die in a pelletizing device for a dry electrode mixture.

FIG. 10 is a front view showing an example of roller dies in a pelletizing device for a dry electrode mixture in a state in which pellets are separated from the roller dies by fluids sprayed from fluid lines.

FIG. 11A and FIG. 11B show a front view and a side sectional view, respectively, showing an example of a roller die in a pelletizing device for a dry electrode mixture, where the roller die includes the fluid lines.

FIGS. 12A, 12B, 13A, 13B and 14 show an example of a disassembly process of a roller die in a pelletizing device for a dry electrode mixture.

FIG. 15 is a view showing an example of a dry electrode mixture in a pellet form manufactured by the pelletizing device for a dry electrode mixture.

FIG. 16 is a view showing an example of a dry electrode mixture in a pellet form including a solid electrolyte film manufactured by a pelletizing device for a dry electrode mixture.

### DETAILED DESCRIPTION

Specific structural and functional descriptions described in implementations of the present disclosure are exemplified merely for the purpose of explaining the implementations according to a concept of the present disclosure, and the implementations according to the concept of the present disclosure may be implemented in various forms. In addition, the present disclosure should not be construed to be limited by the implementations described therein and should be understood to include all modifications, equivalents, or substitutes included in the spirit and technical scope thereof.

Hereinbelow, the present disclosure will be described in detail with reference to the accompanying drawings.

In some implementations, a dry electrode may be prepared from a dry electrode mixture and a current collector without a solvent.

The dry electrode mixture M may include an electrode active material, a conductive additive (also referred to as a conducting agent or conductive material), and a binder. In addition, the dry electrode mixture M may further include an additive.

The dry electrode may be a positive electrode or a negative electrode. In some implementations, when the positive electrode is manufactured, the electrode active material includes a positive electrode active material. As non-limiting examples, the positive electrode active material may include LCO (LiCoO₂), NCM (Li (Ni, Co, Mn) O₂), NCA (Li (Ni, Co, Al) O₂, LMO (LiMnO₄), LFP (LiFePO₄), or sulfur.

In some implementations, when the negative electrode is manufactured, the electrode active material includes a negative electrode active material. For example, the negative electrode active material may include natural graphite, artificial graphite, mesocarbon microbeads (MCMB), or silicon series.

The conductive material may include a carbon-based material. For example, the conductive material may include carbon black, acetylene black, carbon fiber, or carbon nanotube. The binder may include polyvinylidene fluoride (PVDF), polytetrafluoroethylene (PTFE), or a copolymer containing them.

As additives, solid polymer electrolytes, such as poly(ethylene oxide) (PEO), or oxide-based or sulfide-based solid electrolyte components may be used.

In some examples, the ratio of the dry electrode material may include 70 to 99.9 wt % electrode active material, 0.1 to 20 wt % conductive material, and 0.1 to 20 wt % binder. Here, the additive may be added in a ratio of 0 to 20 wt %.

In some implementations, the dry electrode may be an electrode for a secondary battery.

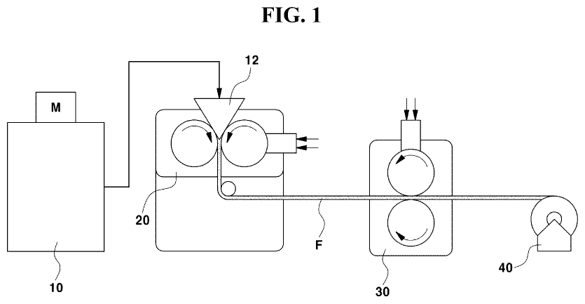

As shown in FIG. 1, the dry electrode mixture M may be manufactured into a dry electrode film F through a series of film forming processes in which heat and pressure are applied. For instance, the dry electrode mixture M including the electrode active material, the conductive material, and the binder is mixed by a mixer 10 at a preset time and speed. As a non-limiting example, the dry electrode mixture may be prepared by a high shear mixer using rotation or a fluidized mixer using air, and the preset time and speed may be controlled by changing the rotation speed and operating time of the mixer 10.

The dry electrode mixture M may refer to a powder in which the electrode active material, conductive material, and binder are appropriately mixed and dispersed through the mixer 10 and may form a film when pressed by a film forming device such as a roll press 20. The dry electrode mixture M may be considered appropriately mixed and dispersed through the fiberization of the binder and the complexation of the conductive material.

The dry electrode mixture M, mixed in the mixer 10, may be formed into a film by a film forming device. For example, the dry electrode mixture M mixed in the mixer 10 may be directed to a feeder 12 or the roll press 20. The dry electrode mixture M may first be pressed into the film at the upstream roll press 20. The upstream roll press 20 rotates while applying a pressing force to form the dry electrode mixture M into a film. In some examples, the dry electrode mixture M, first formed into the film, may be further pressurized in a downstream roll press 30, and the thickness may be controlled through the pressurization. In addition, the dry electrode film F, which is formed from the dry electrode mixture, is wound by a winder 40. Then the dry electrode film F may be bonded or laminated to a current collector to manufacture the dry electrode. The film forming device may also include roll press 30 or the winder 40.

The dry electrode mixture M mixed through the above-described mixing process may undergo through a series of transport processes in order to manufacture the dry electrode. The transport process from the mixer 10 to the feeder 12 in FIG. 1 may be taken as an example of a transport process. In addition, the dry electrode mixture M may be stored for some time before the manufacturing of the dry electrode. As an example, the dry electrode mixture M mixed in the mixer 10 may not be immediately formed into the film and may be transported to a separate storage container for storage.

In some cases, the dry electrode mixture M has a large angle of repose and tends to clump together due to the characteristics of the material. For this reason, the dry electrode mixture M may easily clog a transport pipe during the transport process. In addition, during storage, the dry electrode mixture M located at the bottom of the storage container is pressed down by the weight of the mixture above it, making it prone to clumping.

In order to reuse the dry electrode mixture M, which is clumped together, for the manufacture of dry electrodes, an additional process to break up the clumps may be performed. This may result in additional processing cost and delays in manufacturing time.

Accordingly, the present disclosure aims to provide a dry electrode mixture pelletizing device capable of addressing the issues caused by the clumping characteristics of the dry electrode mixture M that occur during transport or storage. Additionally, in order to accomplish the above-mentioned objective, a device and a method for manufacturing the dry electrode are provided, where the device incorporates the dry electrode mixture pelletizing device.

A pelletizing device 100 may pelletize the dry electrode mixture M. In some implementations, the pelletizing of the dry electrode mixture M may be done between the mixing process by the mixer 10 and the film forming process by the roll press 20. In some implementations, the dry electrode mixture M may be pelletized by the pelletizing device 100.

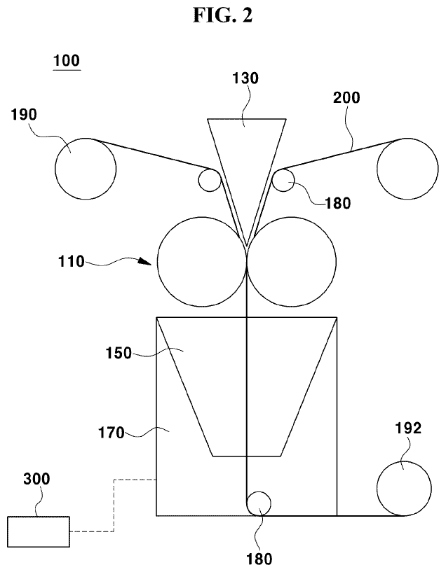

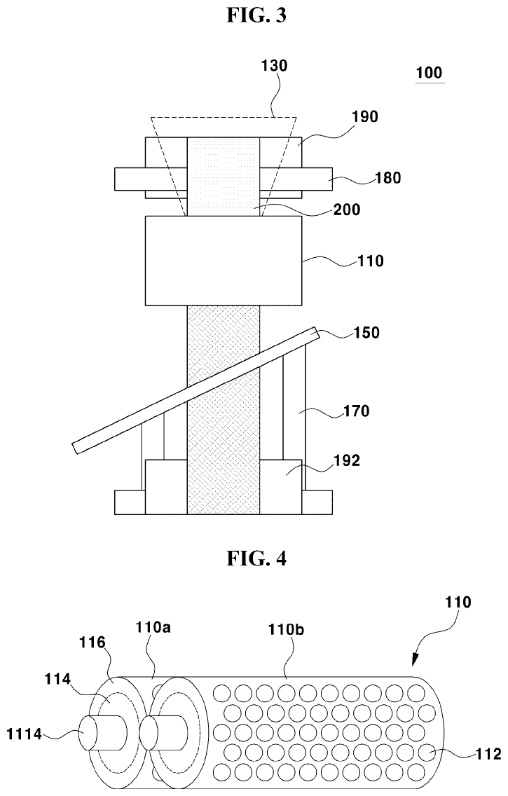

As shown in FIGS. 2 to 3, the pelletizing device 100 may include roller dies 110. The roller dies 110 may pelletize the supplied dry electrode mixture M.

In some implementations, the dry electrode mixture M may be supplied to the roller dies 110 through a hopper 130 positioned above the roller dies 110. In one example, the dry electrode mixture M may be transported from the mixer 10 to the hopper 130. For example, the dry electrode mixture M may be transported from the mixer 10 to the hopper 130 using a vacuum transfer method.

As shown in FIG. 4, the roller dies 110 may include a pellet pattern. In some implementations, the pellet pattern may include recesses 112. Specifically, a plurality of recesses 112 may be provided on the surface of each of the roller dies 110. The dry electrode mixture M supplied between the roller dies 110 may be pelletized through the recesses 112. For example, the pellet pattern may be a curved body, such as a sphere or an ellipsoid. As a non-limiting example, a semi-major axis of the pellet pattern may be greater than 0.05 mm.

In some implementations, the recesses 112 may have a fluorine coating or a fluorine material. As will be described later, this is to account for the reactivity with a solid electrolyte when a solid electrolyte film 200 is used. In some implementations, the roller dies 110 may be coated with tungsten carbide (WC). For example, parts of the roller dies 110 excluding the recesses 112 may be coated with tungsten carbide. This may minimize damage to the roller dies 110 during the pelletization of the positive electrode mixture among the dry electrode mixtures M.

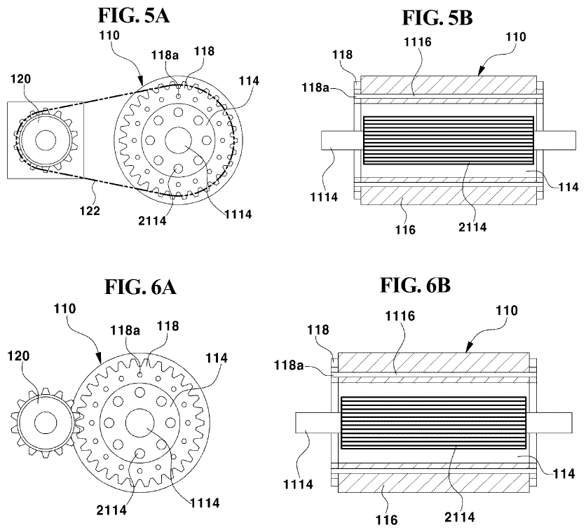

The roller dies 110 may rotate. Each of the roller dies 110 may rotate in opposite directions to one another. In some implementations, each of the roller dies 110 may be supplied with rotational power by a motor 120. In some implementations, as shown in FIG. 5, each of the roller dies 110 may be connected to the motor 120 via a chain 122 or belt to rotate.

In some implementations, as shown in FIG. 6, each of the roller dies 110 may be rotated through a gear coupling with the motor 120. In some examples, a gear 118 may be arranged at the end of each of the roller dies 110. The gear 118 may be provided integrally with each of the roller dies 110 or separately. In some examples, the gear 118 may be connected to each of the roller dies 110 through a fastening member. Each roller die 110 may rotate by the rotational power of the motor 120 transferred to the gear 118 through the chain 122 or a rotary gear. In some implementations, the rotating gear 118 has a diameter smaller than that of the roller die 110. This may prevent the roller dies 110a and 110b from interfering with each other. For instance, the gear 118 may be a ring gear. As will be described later, a core 114 in which heating lines 2114 is provided is fixed, and only a sleeve 116 is configured to rotate, so the gear 118 may be a ring-shaped gear, designed to have substantially the same shape as the sleeve 116. In one example, fluid supply holes 118a may be provided in the gear 118. The fluid supply holes 118a may communicate with fluid lines 1116 provided in the roller die 110.

The pressure by the roller dies 110 may be, for example, at least 0.1 ton. However, the pressure between the roller dies 110 may be adjusted. A gap between the roller dies 110 may be set to zero so that pressure adjustment may not be necessary. However, in case of the positive dry electrode, a gap may be generated, so it may be desirable for the pressure between the roller dies 110 to be adjustable depending on the material of the dry electrode.

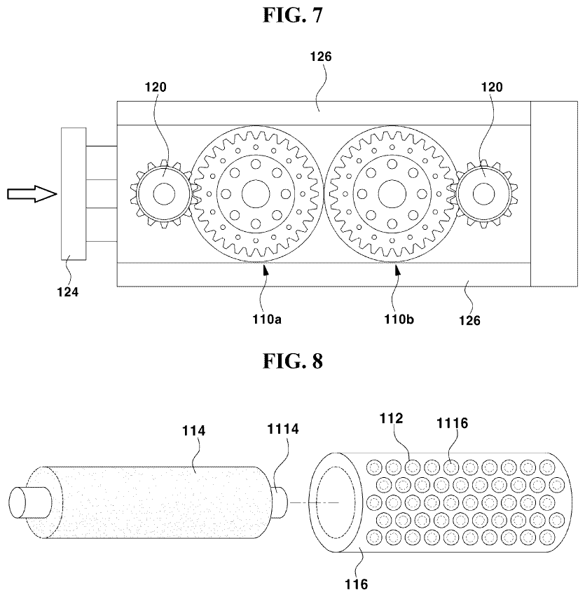

As shown in FIG. 7, pressure adjustment between the roller dies 110 may be achieved by adjusting the distance between the roller dies 110. Specifically, one of the roller dies 110, the first roller die 110a, may be configured to move horizontally. In addition, the second roller die 110b, which is another one of the roller dies 110, may be fixed. That is, the second roller die 110b may be fixed, and the first roller die 110A may be configured to move toward the second roller die 110b or away from the second roller die 110b. To this end, in some implementations, the first roller die 110a may be moved by an actuator 124. As a non-limiting example, the actuator 124 may be a power cylinder. In some implementations, the pelletizing device 100 may include a guide 126. The guide 126 may guide the movement of the first roller die 110a so that the first roller die 110a may only move linearly in a set direction, that is, relative to the second roller die 110b. In some implementations, a pressure smaller than the pressure of the roll press 20 applied when manufacturing the dry electrode film F is applied between the roller dies 110.

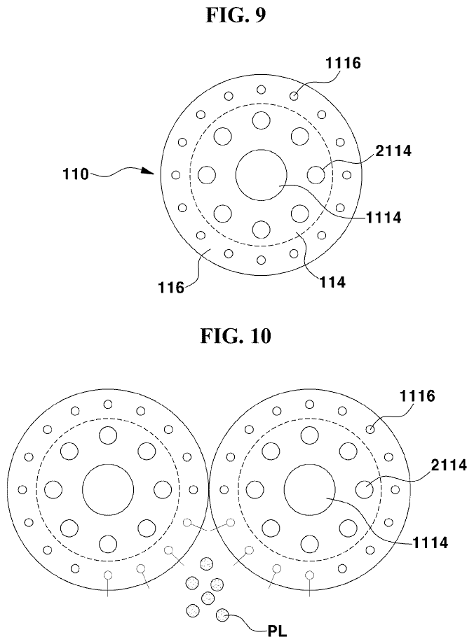

With reference to FIGS. 8 and 9, each of the roller dies 110 may include the core 114 and the sleeve 116. The sleeve 116 is arranged to surround the core 114, and the core 114 and the sleeve 116 may be arranged concentrically. In some implementations, the core 114 is fixed and the sleeve 116 may rotate.

The core 114 may include a fixed shaft 1114 and the heating lines 2114. The fixed shaft 1114 may be fixed to a fixed structure to block the rotation of the core 114. However, the movable first roller die 110a may be capable of horizontal linear movement. The heating lines 2114 allow the temperature of the roller dies 110 to be regulated. In one example, the heating lines 2114 may be configured to allow heat transfer fluid to flow therethrough. In another example, the heating lines 2114 may utilize a coil capable of controlling temperature. The temperature applied to the roller die 110 may be in the range of, for example, 40 to 200° C. In one example, when only the dry electrode mixture M is pelletized without the solid electrolyte film 200, which will be described later, the temperature of the roller dies 110 may be regulated to no greater than 100° C. Heating by the heating lines 2114 may transfer heat to the recesses 112 by heat transfer by the metal. According to the present disclosure, the core 114 including the heating lines 2114 is configured not to rotate, thereby preventing the heating lines 2114 from twisting.

The sleeve 116 may rotate relative to the core 114. Recesses 112, which form the pellet pattern, may be provided on the surface of the sleeve 116. The sleeve 116 may include the fluid lines 1116. The fluid lines 1116 may spray fluid toward the recesses 112. As shown in FIG. 10, the dry electrode mixture M, pelletized by passing through the roller dies 110, may be separated from the roller dies 110 by a fluid sprayed from the fluid lines 1116. To this end, the fluid lines 1116 may be configured for fluid communication with the recesses 112.

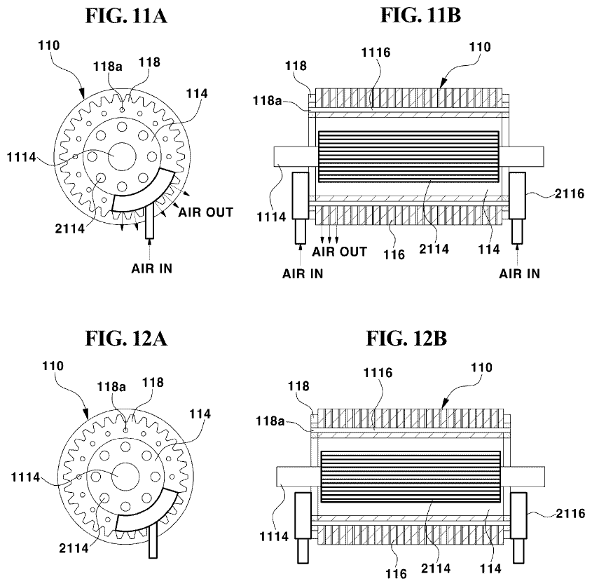

With reference to FIG. 11, in some implementations, the pelletizing device 100 may include a fluid supply device 2116. The fluid supply device 2116 may supply fluid to the fluid lines 1116. For example, the fluid supply device 2116 may be provided at at least an end portion of the roller dies 110. In some implementations, the fluid supply device 2116 may be separated from the end portion of the roller dies 110 while being in contact with the end portion of the roller dies 110.

In some implementations, the fluid may be a pressurized fluid. As a non-limiting example, the fluid may be air. As another non-limiting example, depending on the composition of the solid electrolyte film 200, the fluid may be nitrogen or argon.

In some implementations, the fluid may be sprayed onto the area where the dry electrode mixture Mis exiting the pressurized zone by the roller dies 110. In one example, the fluid may be sprayed onto a lower semicircular area of the roller die 110. In another example, the fluid may be sprayed onto a quadrant of the lower semicircular area of each roller die 110 where the roller dies face each other. The dry electrode mixture M, pelletized through the pressurized zone by the roller dies 110, may be easily separated from the recesses 112 of each roller die 110 by the fluid sprayed onto the quadrant area, as shown in FIG. 11. In one example, during the operation of the pelletizing device 100, the fluid may be sprayed onto the quadrant area; when the pelletizing device 100 is not in operation, the spraying of fluid may be stopped.

In some implementations, the core 114 and the sleeve 116 may be separable from each other such that the sleeve 116 may be replaced. Accordingly, the sleeves 116 with various pellet patterns may be used, allowing for flexible adaptation to process conditions without manufacturing separate roller dies 110 having each pattern.

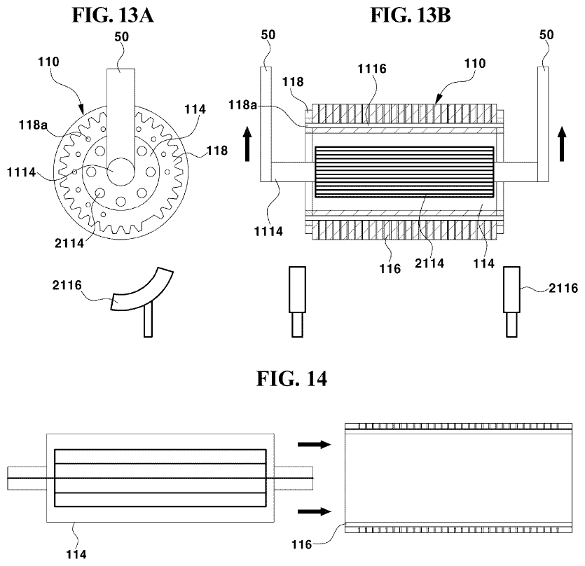

The separation of the core 114 and the sleeve 116 may be accomplished as shown in FIGS. 12 to 14, for example. As shown in FIG. 12, the pelletizing device 100 is in an operable state. As shown in FIG. 13, a tool, such as a belt 50, may be attached to the fixed shaft 1114, which may be removed by a hoist. As shown in FIG. 14, the sleeve 116 may be easily replaced by separating the sleeve 116 from the core 114. In one example, the surface of the core 114 may include ball rollers to facilitate the attachment and detachment of the sleeve 116 and allow the sleeve 116 to smoothly rotate during the operation of the pelletizing device 100.

With reference to FIGS. 2 to 3, the dry electrode mixture M, pelletized through the roller dies 110, may be collected beneath the roller dies 110. In one example, a collection surface 150 and a support body 170 may be provided beneath the roller dies 110. The support body 170 is configured to support the collection surface 150. The collection surface 150 may be inclined, allowing the pellets PL discharged from the roller dies 110 to be easily collected.

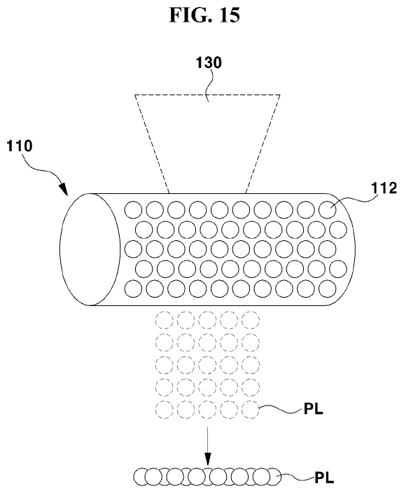

As shown in FIG. 15, the pellets PL of the dry electrode mixture M may be manufactured by the pelletizing device 100. The dry electrode mixture M, supplied between the roller dies 110 from the hopper 130, is subjected to heat and pressure. This activates a portion of the binder in the electrode mixture M that comes into contact with the recesses 112, allowing the dry electrode mixture M to form pellets that do not clump together. The pellets PL discharged from the roller dies 110 may be transported to the roll press 20 or stored in a separate storage container. The pellets PL may maintain a form that may not break during transportation or storage, thereby improving flowability and addressing clumping issues. The pellets PL may be easily broken when subjected to a certain amount of pressure from the roll press 20 during the manufacture of the dry electrode film F, from which the dry electrode film F that is free-standing may be produced.

In some implementations, the pelletizing device 100 may produce pellets 210 with a core-shell structure, in which the pellets PL are surrounded by the solid electrolyte film 200. In particular, the film-surrounded pellet 210 may be used in a dry electrode for an all-solid-state battery. In the present specification, the film-surrounded pellet 210 refers to placing the pellet PL being a pelletized dry electrode mixture M within a solid electrolyte film 200.

In some examples, when manufacturing an all-solid-state electrolyte where a solid electrolyte is utilized, the interfacial resistance between the electrolyte and the electrode becomes significantly high. Due to this reason, composite electrodes that mix electrolyte materials into the electrode can be used. In some cases, for the production of the dry electrode mixture, a high shear force may be used for fiberization of the binder (that is, the mixing process by the mixer 10). In some cases, when the components of the dry electrode mixture and the solid electrolyte are mixed to obtain a composite electrode, segmental motion may become difficult due to the high shear force breaking the polymer chains. In addition, it can be difficult to achieve a uniform mixture of the solid electrolyte and the dry electrode mixture.

The present disclosure can enable the solid electrolyte to act only under specific conditions (such as heat and pressure applied by the roll press 20) without applying high shear force to the solid electrolyte, through the pellet 210 surrounded by a film, using a core-shell structure. That is, the solid electrolyte having a core-shell structure with the dry electrode mixture is formed into the dry electrode film F by experiencing rearrangement of its polymer by pressure applied during film formation through the roll press 20, ensuring a uniform distribution of the solid electrolyte within the dry electrode.

With reference to FIGS. 2 to 3, to manufacture film-surrounded pellets 210, the pelletizing device 100 may include unwinders 190 configured to supply the solid electrolyte film 200 between the roller dies 110. The unwinder 190 may unwind the solid electrolyte film 200 wound thereon. In one example, the unwinders 190 may be positioned at each side of the hopper 130, with the hopper 130 in the middle. In this arrangement, the dry electrode mixture M may be supplied from the hopper 130 between two layers of solid electrolyte films 200 the dry electrode mixture M may be supplied from the hopper 130 between the two layers of solid electrolyte films 200, supplied by each unwinder 190.

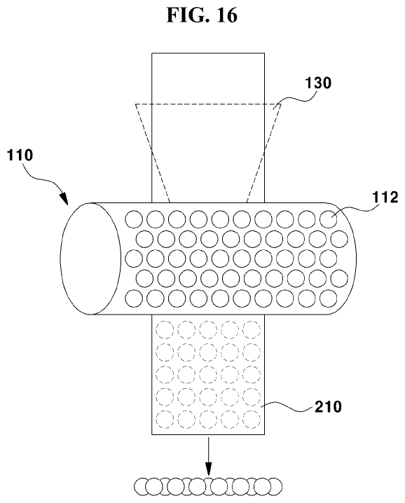

As shown in FIG. 16, the dry electrode mixture M passing through the roller dies 110 may be pelletized. In some examples, as shown in FIG. 15, a solid electrolyte film 200 may not be provided. In some examples, it may be pelletized while surrounded by the solid electrolyte film 200. The discharge from the roller dies 110 may be pellets surrounded by two layers of the solid electrolyte films 200.

The solid electrolyte film 200 is wound onto each of the unwinders 190, extends along a predetermined path, and is connected to a rewinder 192. The solid electrolyte film 200 that is not used during pelletization may be wound by the rewinder 192 located downstream of the roller dies 110 for reuse.

In some implementations, idle rollers 180 may be placed between the unwinders 190 and the roller dies 110 to guide the progress of the solid electrolyte film 200. In some implementations, an idle roller 180 may be placed between the roller dies 110 and the rewinder 192 to guide the progress of the solid electrolyte film 200.

The dry electrode mixture M supplied from the hopper 130 to the roller dies 110, along with the solid electrolyte film 200 from the unwinder 190, may be pelletized by applying heat and pressure at the roller dies 110. The film-surrounded pellets 210 discharged from the roller dies 110 may be transported to the roll press 20 to undergo film formation or be stored in a separate container.

In some implementations, the solid electrolyte film 200 may be manufactured by dissolving a lithium salt in a polymer, followed by a coating process.

The polymer may include ethylene oxide and acrylate. For example, a single polymer including both ethylene oxide and acrylate, such as polyethylene glycol dimethacrylate, may be used. As another example, two substances containing components of ethylene oxide and acrylate, respectively, may be used in a mixture.

The lithium salt may include lithium bis(trifluoromethanesulfonyl) imide.

In some implementations, the ratio of the polymer EO to the lithium salt Li is EO:Li=x:1 where x is no greater than 50.

In some implementations, an initiator, ranging from 0.1 to 5 wt %, may be added after preparing a solution of the polymer and lithium salt. In one example, when a solid electrolyte film is manufactured through thermal polymerization, a thermal radical polymerization initiator may be added. The thermal radical polymerization initiator may include t-butyl peroxypivalate, di-tert-butyl peroxide, ammonium peroxodisulfate, or the like. In another example, when a solid electrolyte film is manufactured by photocuring, a photo radical polymerization initiator may be added. The photo radical polymerization initiator may include benzil, benzophenone, benzoin isopropyl ether, or benzoin ethyl ether.

The post-coating treatment method for solutions of polymers and lithium salts varies depending on the type of initiator used. In case of the thermal radical polymerization initiator, heat treatment is performed at 60 to 200° C. after coating, and in case of the photo radical polymerization initiator, exposure to an ultraviolet (UV) lamp may be applied.

Once the curing is complete, the manufacturing of the solid electrolyte film is finished. The thickness of the solid electrolyte film may vary, ranging from hundreds of nanometers to hundreds of micrometers. In some implementations, the thickness of the solid electrolyte film may be produced at 1 to 50 wt % of the weight ratio of the dry electrode mixture pellets.

The pelletizing device 100 may further include a controller 300. The controller 300 is configured to control the operation of the pelletizing device 100. In some implementations, the controller 300 may operate the heating lines 2114. For example, the controller 300 may operate the heating lines 2114 for a preset period of time. In one implementation, the controller 300 may operate the fluid supply device 2116. For example, the controller 300 may supply fluid to the fluid lines 1116 at a preset time. As shown in Table 1, the performance of dry electrodes manufactured from the dry electrode mixture in pellet form was compared to that of dry electrodes made from the same mixture not in pellet form. Dry electrode mixture pellets were manufactured at room temperature under a pressure of 1 ton. The working electrode is the cathode, while the counter/reference electrode is lithium metal. The electrolyte used was a 1 molar concentration (M) of LiPF₆ in EC/DEC with FEC. Charge and discharge were performed once at 0.1 C and 0.33 C under the specified conditions, followed by a 20-minute rest period after completion.
Charging: CC/CV mode, cut-off at 4.25 V, 0.05 C
Discharging: CC mode, cut-off at 2.5 V

TABLE 1

| | | | | | | 0.1 C | 0.33 C |
|---|---|---|---|---|---|---|---|
| | Electrode | Electrode | Electrode | Electrode | LoadIng | Discharging | Discharging |
| | weight | Thickness | Area | Capacity | Value | capacity | capacity |
| Division | [g] | [um] | [cm²] | [mAh/g] | [mg/cm²] | [mAh/g] | [mAh/g] |
| Pellet is | 0.01277 | 80 | 0.785 | 223.85 | 16.3 | 201.3 | 200.4 |
| used | | | | | | | |
| Pellet is | 0.01277 | 80 | 0.785 | 223.85 | 16.3 | 200.7 | 199.9 |
| not used | | | | | | | |

As shown in Table 1, pelletizing the dry electrode mixture (by applying heat and pressure) may not affect its performance.

According to the present disclosure, a dry electrode mixture pelletizing device and a dry electrode manufacturing device, both capable of facilitating the transport and storage of the dry electrode mixture, are provided. In addition, there may not be adverse effect on the quality or performance of the dry electrode manufactured using the dry electrode manufacturing device according to the present disclosure.

Pelletization of the dry electrode mixture, as described in the present disclosure, may be advantageous in terms of dispersibility when manufacturing a composite electrode for an all-solid-state electrolyte. In addition, the present disclosure enables the manufacture of a dry composite electrode without deteriorating the properties of the solid electrolyte as the solid electrolyte is subjected only to the heat and pressure set in the pelletizing device, without the high shear force during the manufacture of the dry electrode mixture.

In some implementations, the device of manufacturing the dry electrode may include the pelletizing device 100.

In some implementations, the method of manufacturing the dry electrode may include the pelletizing process for the dry electrode mixture M.

Although the present specification primarily describes pelletizing the dry electrode mixture, the pelletizing device according to the present disclosure may also be applied to powders similar to dry electrode mixtures.

The present disclosure described above is not limited to the above-described implementations and the accompanying drawings, and it will be obvious to those skilled in the art that various substitutions, modifications, and changes are possible without departing from the technical spirit of the present disclosure.

What is claimed is:

1. A method for manufacturing a dry electrode, the method comprising:
supplying a dry electrode mixture to a pelletizing device, the pelletizing device including a pellet pattern;
pelletizing the dry electrode mixture using the pelletizing device to generate a pelletized dry electrode mixture; and
supplying the pelletized dry electrode mixture to a film forming device.

2. The method of claim 1, wherein pelletizing the dry electrode mixture comprises:
applying pressure to the dry electrode mixture passing through the pelletizing device.

3. The method of claim 2, wherein pelletizing the dry electrode further comprises:
heating the dry electrode mixture passing through the pelletizing device.

4. The method of claim 1, wherein pelletizing the dry electrode comprises:
spraying fluid toward the pellet pattern through a fluid line provided in the pelletizing device to separate a dry electrode mixture pellet from the pelletizing device.

5. The method of claim 1, wherein the pellet pattern comprises one or more recesses that are recessed from a surface of the pelletizing device.

6. The method of claim 1, wherein supplying the dry electrode mixture to the pelletizing device comprises:
supplying a solid electrolyte film to the pelletizing device such that the dry electrode mixture is surrounded by the solid electrolyte film.

7. The method of claim 6, wherein pelletizing the dry electrode mixture comprises:
obtaining a pellet from the pelletizing device in a state in which the dry electrode mixture is surrounded by the solid electrolyte film.

8. The method of claim 7, wherein the solid electrolyte film comprises a polymer, a lithium salt, and an initiator.

9. The method of claim 1, further comprising:
before supplying the dry electrode mixture to the pelletizing device, obtaining the dry electrode mixture by mixing an electrode active material, a binder, and a conductive material.

10. The method of claim 1, further comprising:
forming a dry electrode film from the pelletized dry electrode mixture supplied to the film forming device.

11. The dry electrode manufactured using the pelletized dry electrode mixture according to claim 1.

12. A battery comprising the dry electrode according to claim 11.

13. A pelletizing device, comprising:
a plurality of roller dies that include a pellet pattern, the plurality of roller dies being configured to apply at least one of heat or pressure to a material that passes through the plurality of roller dies.

14. The pelletizing device of claim 13, wherein the pellet pattern comprises:
one or more recesses that are recessed from a surface of each of the plurality of roller dies.

15. The pelletizing device of claim 13, wherein each of the plurality of roller dies comprises:
a core; and
a sleeve that surrounds the core and is configured to rotate around the core.

16. The pelletizing device of claim 15, wherein the core is fixed to the pelletizing device and comprises a heating line configured to transfer heat.

17. The pelletizing device of claim 15, wherein the sleeve comprises:
a fluid line that is in fluidly communication with the pellet pattern.

18. The pelletizing device of claim 15, further comprising:
a hopper configured to supply the material to the plurality of roller dies; and
an unwinder configured to supply a film to the plurality of roller dies.

19. The pelletizing device of claim 18, wherein the unwinder is one of at least two unwinders, each of the at least two unwinders being configured to supply the film to one of the plurality of roller dies with the material placed between the plurality of roller dies.

20. The pelletizing device of claim 13, wherein the material comprises an electrode active material, a binder, and a conductive material.
